(19) United States
(12) Patent Application Publication
(10) Pub. No.: US 2003/0116965 A1
(43) Pub. Date: Jun. 26, 2003

(54) Pipe connection device

(76) Inventor: Ming-Hsin Hsu, Taichung (TW)

Correspondence Address: Ming-Hsin Hsu, 58, MA YUAN WEST ST., TAICHUNG, TW

(21) Appl. No.: 10/036,244

(22) Filed: Dec. 26, 2001

(51) Int. Cl. F16L 39/00

(52) U.S. Cl. 285/321

(57) ABSTRACT

A pipe connection device has a C-shaped ring, an O-shaped ring, at least a first annular collar to receive the C-shaped ring, and at least a second annular collar to receive the O-shaped ring. The first annular collar has a tapering portion and at least an insertion hole.

### BACKGROUND OF THE INVENTION

The present invention relates to a pipe connection device.

Referring to FIG. 1, a conventional pipe connection device 101 is disposed on an end of a pipe 100. Only an O-ring is disposed between the pipe 100 and the conventional pipe connection device 101. However, an assembly of the pipe 100 and the conventional pipe connection device 101 is not very stable.

Referring to FIG. 1A, another conventional pipe connection device 300 is disposed on an end of a pipe 200. The pipe 200 and the conventional pipe connection device 300 are connected by a threaded connection method. However, a leakage between the pipe 200 and the conventional pipe connection device 300 often occurs.

### SUMMARY OF THE INVENTION

An object of the present invention is to provide a pipe connection device which has a first annular collar to receive a C-shaped ring and a second annular collar to receive an O-shaped ring so that the C-shaped ring can clamp an annular recess of a pipe.

Another object of the present invention is to provide an insertion hole on a first annular collar of a pipe connection device in order to receive a pin while the pipe connection device is detached from a pipe.

Accordingly, a pipe connection device comprises a C-shaped ring, an O-shaped ring, at least a first annular collar to receive the C-shaped ring, and at least a second annular collar to receive the O-shaped ring. The first annular collar has a tapering portion and at least an insertion hole.

### BRIEF DESCRIPTION OF THE DRAWINGS

FIG. 1 is a perspective view of a first conventional pipe connection device of the prior art connected to a pipe;

FIG. 1A is a perspective view of a second conventional pipe connection device of the prior art connected to a pipe;

FIG. 2 is a perspective view of a pipe connection device of a preferred embodiment in accordance with the present invention;

FIG. 3 is a schematic view illustrating an operation of a pipe connection device of a preferred embodiment while a pipe is inserted in the pipe connection device;

FIG. 4 is a perspective assembly view of a pipe connection device of a preferred embodiment and two pipes;

FIG. 5 is a sectional assembly view of a T-shaped joint, three pipes, and three pipe connection devices of a preferred embodiment in accordance with the present invention;

FIG. 6 is a schematic view illustrating a detachment of a pipe connection device of a preferred embodiment from a pipe; and

FIG. 7 is another schematic view illustrating a detachment of a pipe connection device of a preferred embodiment from a pipe.

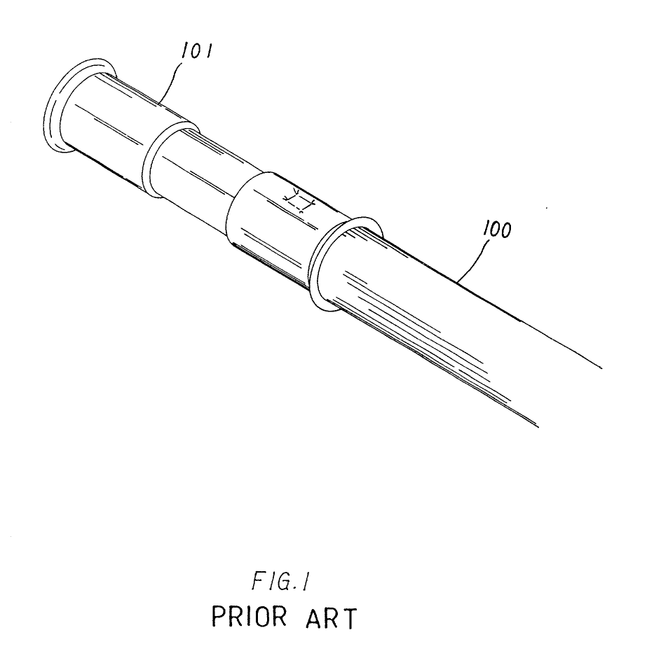

### DETAILED DESCRIPTION OF THE INVENTION

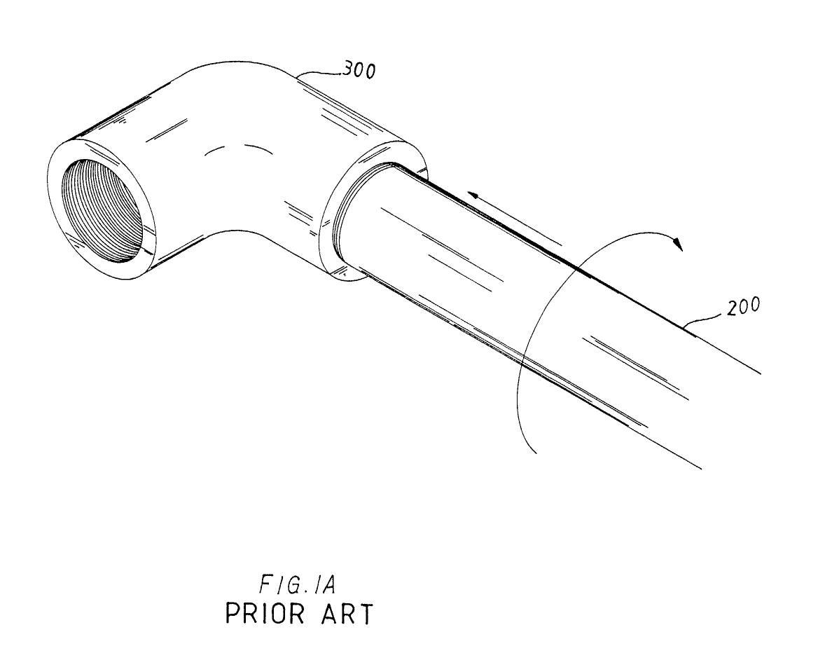

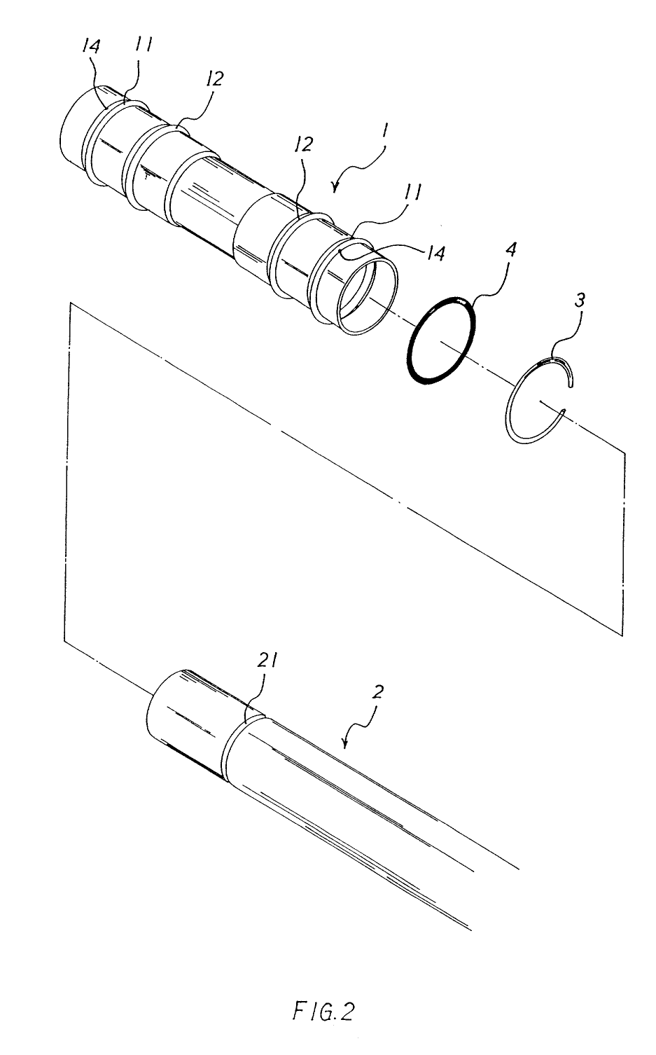

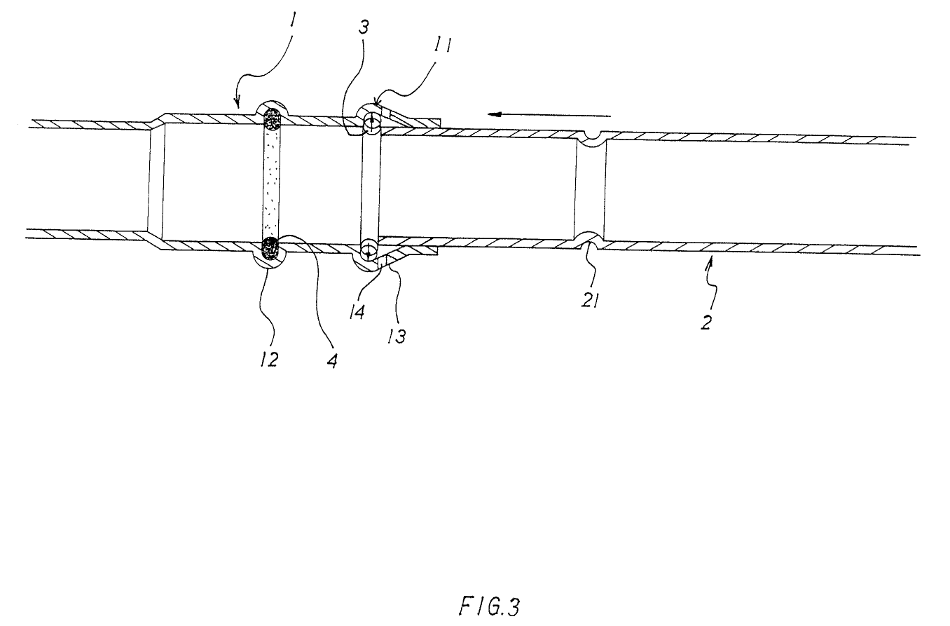

Referring to FIGS. 2 to 4, a pipe connection device 1 comprises a C-shaped ring 3, an O-shaped ring 4, at least a first annular collar 11 to receive the C-shaped ring 3, and at least a second annular collar 12 to receive the O-shaped ring 4.

The first annular collar 11 has a tapering portion 13 and at least an insertion hole 14.

A pipe 2 has an annular recess 21. When the pipe 2 is inserted in the pipe connection device 1, the C-shaped ring 3 clamps the annular recess 21 of the pipe 2.

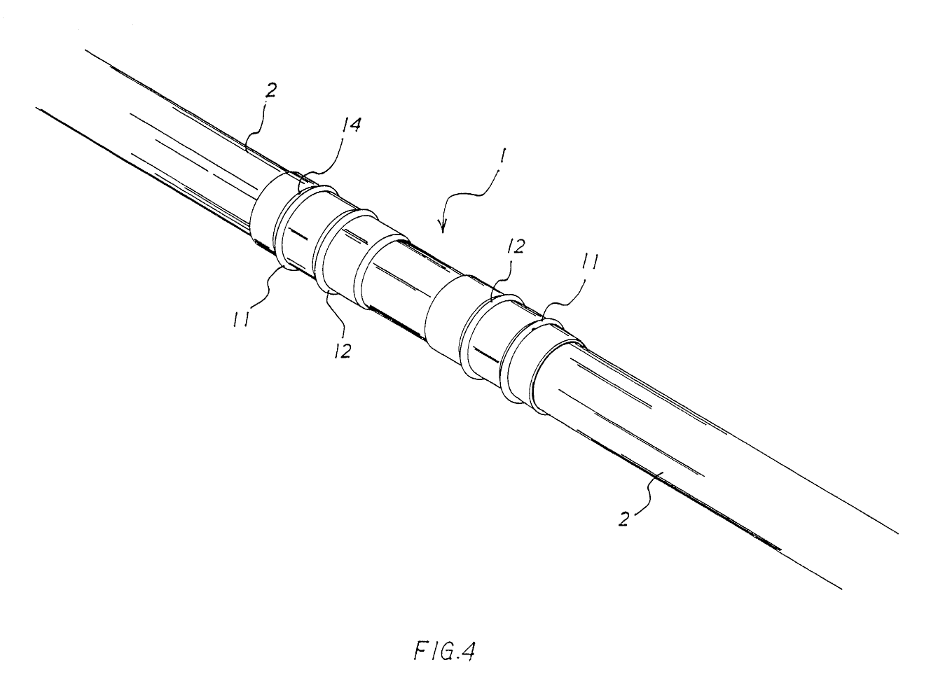

Referring to FIG. 5, a T-shaped joint 10, three pipe connection devices 1, and three pipes 2 are assembled together.

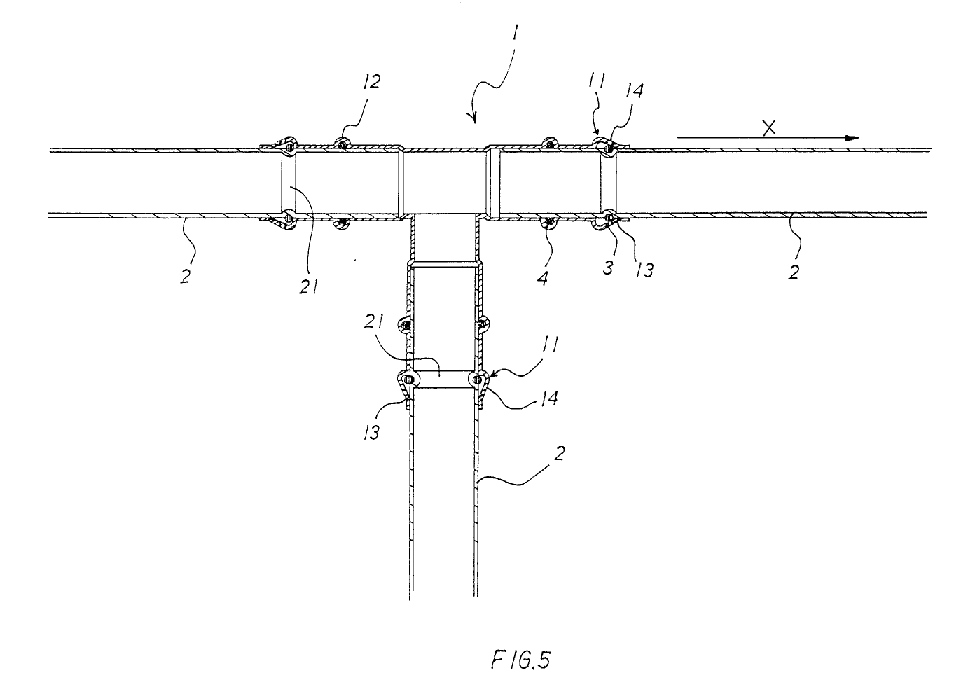

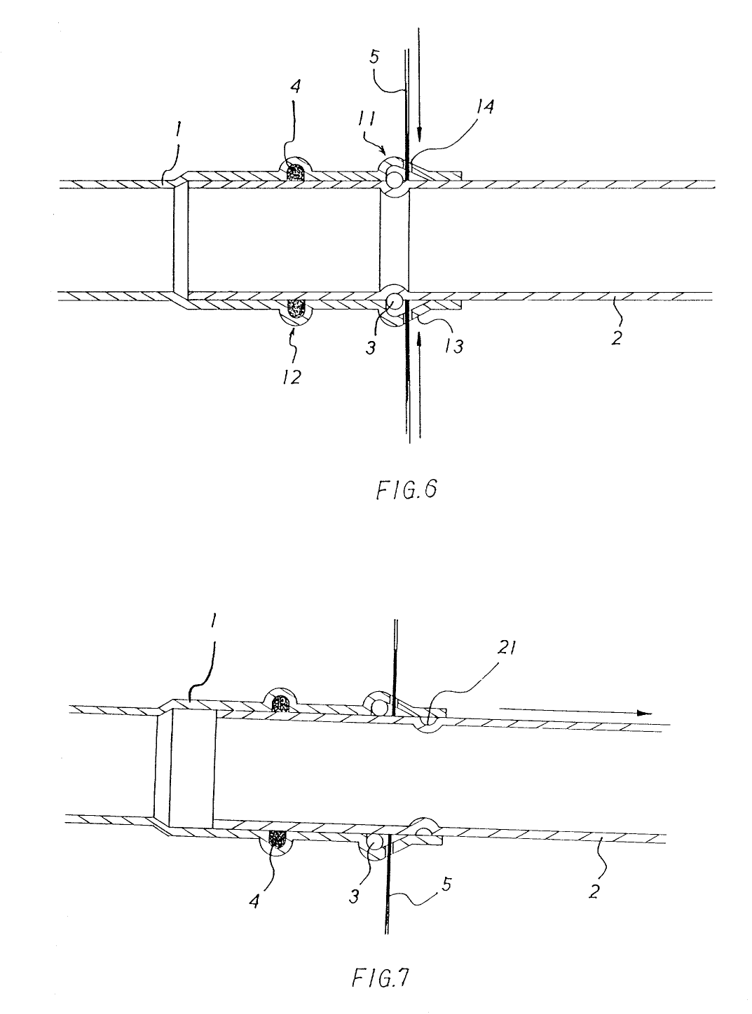

Referring to FIGS. 6 and 7, a pin 5 is inserted in the insertion hole 14 of the first annular collar 11 before the pipe 2 is detached from the pipe connection device 1.

The present invention is not limited to the above embodiment but various modification thereof may be made. Furthermore, various changes in form and detail may be made without departing from the scope of the present invention.

I claim:

1. A pipe connection-device comprises:
a C-shaped ring, an O-shaped ring, at least a first annular collar to receive the C-shaped ring, and at least a second annular collar to receive the O-shaped ring, and
the first annular collar having a tapering portion and at least an insertion hole.
